(19) United States
(12) Patent Application Publication
(10) Pub. No.: US 2026/0203942 A1
(43) Pub. Date: Jul. 16, 2026

(54) CYLINDRICAL PROJECTION FOR SENSOR CALIBRATION

(71) Applicant: QUALCOMM Incorporated, San Diego, CA (US)

(72) Inventors: Andreas EIDEHALL, Linköping (SE); Goesta HULDT, Linköping (SE)

(21) Appl. No.: 19/025,790

(22) Filed: Jan. 16, 2025

(51) Int. Cl. G06T 7/80; G06T 17/00; G06V 20/10

(52) U.S. Cl. CPC G06T 7/80; G06T 17/00; G06V 20/176

(57) ABSTRACT

Systems and techniques are described herein for sensor calibration. For example, a computing device can process a visual representation of an environment to generate a cylindrical projection of the visual representation. The computing device can determine a reference line associated with an object represented in the cylindrical projection. The computing device can adjust parameters of a sensor based on an orientation of the reference line.

### FIELD

The present disclosure generally relates to calibration techniques for sensor calibration. For example, aspects of the present disclosure relate to systems and techniques for using cylindrical projections for sensor (e.g., image sensors such as cameras) calibration.

### BACKGROUND

The capabilities of sensors can change as extrinsic and intrinsic parameters of the sensors change. For example, degradation of components of sensors over time can affect sensor calibration. Other factors such as unintended movement of a sensor can be represented as changes in extrinsic parameters causing the sensor to become de-calibrated. Many systems and devices (e.g., autonomous and semi-autonomous cars, drones, mobile robots, mobile devices, extended reality (XR) devices, and other systems or devices) include multiple sensors to gather information about the environment. Calibration of sensors is used to ensure accuracy of sensor data as extrinsic and intrinsic parameters of the sensor deviate over time. In the examples of systems and devices that use sensors to control motion of a system (e.g., an autonomous or semi-autonomous car), sensor data accuracy can be crucial to providing a safe and comfortable experience to users.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for sensor calibration is provided. The apparatus includes at least one memory and at least one processor coupled to the at least one memory and configured to: process a visual representation of an environment to generate a cylindrical projection of the visual representation; determine a reference line associated with an object represented in the cylindrical projection; and adjust parameters of a sensor based on an orientation of the reference line.

In some aspects, a method for sensor calibration is provided. The method includes: processing a visual representation of an environment to generate a cylindrical projection of the visual representation; determining a reference line associated with an object represented in the cylindrical projection; and adjusting parameters of a sensor based on an orientation of the reference line.

In some aspects, a non-transitory computer-readable medium is provided having stored thereon instructions that, when executed by at least one processor, cause the at least one processor to: process a visual representation of an environment to generate a cylindrical projection of the visual representation; determine a reference line associated with an object represented in the cylindrical projection; and adjust parameters of a sensor based on an orientation of the reference line.

In some aspects, an apparatus for sensor calibration is provided. The apparatus includes: means for processing a visual representation of an environment to generate a cylindrical projection of the visual representation; means for determining a reference line associated with an object represented in the cylindrical projection; and means for adjusting parameters of a sensor based on an orientation of the reference line.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image capture and processing system, in accordance with some examples.

FIG. 2 is a block diagram illustrating an example device that can generate cylindrical projections from image and perform sensor calibration, in accordance with some examples.

FIG. 3 is a block diagram illustrating an example of warping of cylindrical projections from incorrect parameter calibration, in accordance with some examples.

FIG. 4 is a block diagram illustrating an example of effects of incorrect parameter calibration of an image sensor, in accordance with some examples.

FIG. 5 is a block diagram illustrating examples of projections of straight vertical edges into an image, in accordance with some examples.

FIG. 6 is a block diagram of a system for calibrating a sensor, in accordance with some examples.

FIG. 7 is a block diagram of another system for calibrating a sensor, in accordance with some examples.

FIG. 8 is a flow diagram illustrating an example process for calibrating a sensor, in accordance with some examples.

FIG. 9 is a block diagram illustrating an example neural network, in accordance with some examples.

FIG. 10 is a block diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As mentioned previously, the capabilities of sensors can change as extrinsic and intrinsic parameters of the sensors change. The degradation of components of sensors can affect sensor calibration. Extrinsic parameters of sensors, such as the position, orientation, and movement of the sensors can affect sensor calibration. Many systems and devices (e.g., autonomous and semi-autonomous vehicles (e.g., cars), drones, mobile robots, mobile devices, extended reality (XR) devices, and other systems or devices) include multiple sensors to gather information about the environment. Calibration of sensors ensures accuracy of sensor data as the accuracy of the sensors deviate over time.

The capabilities of sensors can be represented as parameters of the sensors. The parameters can include intrinsic parameters of the sensors and extrinsic parameters of the sensors. Intrinsic parameters of sensors can include software value representations of the capabilities of the hardware. For example, the intrinsic parameters of sensors can include skew, focal length, range, resolution, operating temperature, etc. Extrinsic parameters (also referred to as extrinsics) of sensors can include the position, orientation (pitch, roll, yaw, etc.), and movement of the sensors. Sensors can lose accuracy (e.g., become de-calibrated) when the intrinsic parameters and extrinsic parameters deviate from expected values.

For example, sensors that are part of systems that generally operate in motion (e.g., a semi-autonomous or autonomous vehicle, a mobile robot, drone, etc.) can experience de-calibration resulting from adjustments to a position or orientation of the sensors. For example, an image sensor can be used by a vehicle as a backup camera. Vehicle can overlay a graph over images captured by the image sensor indicating to the user distances from objects in view of the image sensor. In examples where the distances are determined based on an expected angle or position of the image sensor, an adjustment of the position or orientation of the sensor can affect the accuracy of determined distances.

In another example, sensors that are part of systems that primarily operate outside can experience thermal cycles resulting from fluctuations in temperature and weather. The thermal cycles can cause the expansion and contraction of components of the system. For example, a bracket attaching a sensor to a vehicle can expand or contract based on the temperature. The numerous expansions and contractions can warp the bracket affecting the position or orientation of the sensor. A change in the position and orientation of the sensor can be represented as a change in extrinsic parameters of the sensor. The change in extrinsic parameters can represent a de-calibration of the sensor and affect the accuracy of sensor data captured by the sensor. Calibration of sensors is important to ensure accuracy of the sensor data as the capabilities of the sensor, represented by the intrinsic parameters and extrinsic parameters of the sensor, changes. Further, changes in accuracy of a sensor can cause a system (e.g., an autonomous vehicle) to be out of compliance with laws and regulations for safe operation.

Image sensors (e.g., cameras) on vehicles (e.g., cars, trucks, etc.) can be especially impacted by fluctuations in temperature and adjustments to orientation due to motion. Rough road conditions (e.g., potholes, gravel, speed bumps, etc.) can cause jostling or vibration of cameras that are not securely fastened to a vehicle. Further, vehicles are generally used for long periods of time and are often kept outside. In some environments, temperature conditions can vary 30 or more degrees Fahrenheit within a day and 90 or more degrees Fahrenheit between seasons (e.g., difference between summer high temperatures and winter low temperatures). Image sensors located on an exterior of the vehicle, such as parking cameras can be exposed directly to the temperatures affecting the intrinsic parameters of the parking cameras and potentially affecting the extrinsic parameters of the parking camera by affecting components mounting the parking camera to the vehicle. Further, the initial extrinsic and intrinsic parameters of sensors can be suboptimal from an insufficient factory calibration. For example, errors in manufacturing of sensors or assembly of components (e.g., incorrect placement or orientation of sensors) can affect sensor calibration.

Systems, apparatuses, methods (also referred to as processes), and computer-readable media (collectively referred to herein as “systems and techniques”) are described herein that provide calibration techniques for parameters (e.g., intrinsic parameters and extrinsic parameters) of sensors. For example, the sensor can be an image sensor such as a camera. The sensor can be part of a system or device such as a vehicle, robot, XR device, etc. The systems and techniques can include updating software or applications associated with the image sensor. The systems and techniques can determine parameters during use of the image sensor by performing dynamic calibration of the image sensor. For example, the image sensor can be calibrated while the sensor is online or in use by a system.

In some aspects, the systems and techniques can include capturing or generating a visual representation of an environment an image using an image sensor, such as a camera. The systems and techniques can generate a cylindrical image projection of the image (also referred to as the cylindrical image or cylindrical projection). For example, the systems and techniques can warp the image to generate the cylindrical projection by applying a warping algorithm to the image to apply distortions to the image (e.g., shifting/adjustments to pixel values of the image). The systems and techniques can generate the cylindrical projection by applying a warping algorithm associated with cylindrical projections around a vertical cylindrical axis. By using a vertical cylindrical axis, vertical structures in the world (represented in the image) can be warped to be vertical in the cylindrical image projection. For example, vertical structures in the real-world can project to vertical structures in the visual representation. In some examples, the visual representation can be an image, a three-dimensional point cloud, and/or other multimodal and spatial data.

For example, some image sensors or cameras can include distortions in an image (or other visual representation such as a three-dimensional point cloud) due to the hardware of the image sensor or due to a perspective view. In such an example, an image sensor, such as a fish-eye camera or 360 degree camera, can generate images which can include warping of objects represented within the image (or other visual representation) such as by curving objects. In other examples, the position of the camera relative to an object represented in an image can cause the object to appear slanted or distorted due to perspective of the object. For example, an object can be vertical in the real-world. The orientation of the image sensor (e.g., pitch, roll, yaw, etc.) can cause the object to be represented in the image at an angle or slanted. Deviations in vertical lines of objects within the real-world and the representation of the objects in the image can indicate that the image sensor is rotated relative to a scene/object represented in the visual representation.

In some aspects, the systems and techniques can determine a reference line associated with an object represented in the cylindrical projection. For example, the reference line can be associated with a portion of the object which is generally straight and vertical. For example, the object can be a building, traffic sign, street sign, or light post. The reference line can be an edge (e.g., a corner) of the building or a pole of the traffic sign. In some examples, the systems and techniques can include performing object detection on the image generated by the image sensor or the cylindrical projection to identify objects of a predetermined class based on the objects of the predetermined class having vertical lines or edges. For example, the systems and techniques can include using a machine learning model, such as a neural network, classifier model, object detection model, etc., to identify a building in an image or cylindrical projection. The machine learning model can identify the building and determine a reference line associated with an edge of the building.

In some aspects, the systems and techniques can include adjusting parameters of the sensor (e.g., the image sensor which generated the image) based on an orientation of the reference line. For example, the reference line associated with the object can be at an angle. In some examples, the systems and techniques can include adjusting parameters of the sensor such that subsequent images captured by the sensor illustrate the reference line as vertical in the cylindrical projection. In one such example, the systems and techniques can determine an updated orientation (e.g., adjust parameters) of the sensor (e.g., the shifted orientation of the sensor) based on warping of the cylindrical projection, and update values used to generate the cylindrical projection based on the updated orientation of the sensor. In further examples, the systems and techniques can determine adjusted parameters of the sensor based on a geometric relationship between angles of the reference line and the sensor. In another example, the systems and techniques can include adjusting a roll, pitch, or yaw of the sensor. For example, the sensor can be mounted on an adjustable component (e.g., adjustable mount, adjustable bracket, etc.). In such an example, the systems and techniques can include adjusting the orientation of the sensor based on the orientation of the reference line.

In some aspects, the systems and techniques can use a machine learning model to determine reference lines of the cylindrical projection. As mentioned above, the machine learning model can perform object detection techniques to detect objects of a predetermined class to identify reference lines. For example, the machine learning model can be trained to identify reference lines associated with objects that are generally straight and vertical in the real-world. In such an example, the machine learning model can be trained using supervised or unsupervised learning techniques. For example, the machine learning model can be trained using annotated images or annotated cylindrical projections. The annotations can include reference lines associated with an object represented in the annotated image or annotated cylindrical projections.

In some aspects, the systems and techniques can include filtering the adjusted parameters to average the adjusted parameters over time. For example, the systems and techniques can include performing an iterative process using the image or cylindrical projection to determine parameters of the sensor to adjust. For example, the systems and techniques can include processing an image into a cylindrical projection, determining reference lines associated with objects represented in the cylindrical projection, and adjusting parameters of a sensor based on the orientation of the reference line as a first iteration of the iterative process. Subsequent iterations can include performing the iterative process again to identify errors or generate a weighted average of adjusted parameters to be applied to the sensor.

For example, the filter can be a Kalman filter to adjust parameters based on past adjusted parameters. In some examples, the iterative process can include using the image or the cylindrical projection for multiple iterations of adjusting the parameters. In further examples, the iterative process can include using additional images or additional cylindrical projections for different iterations of adjusting the parameters. For example, a first image or first cylindrical projection can be used for a first iteration and a second image or second cylindrical projection can be used for the second iteration. In further examples, the iterative process can include using different reference lines for iterations.

Various aspects of the application will be described with respect to the figures below.

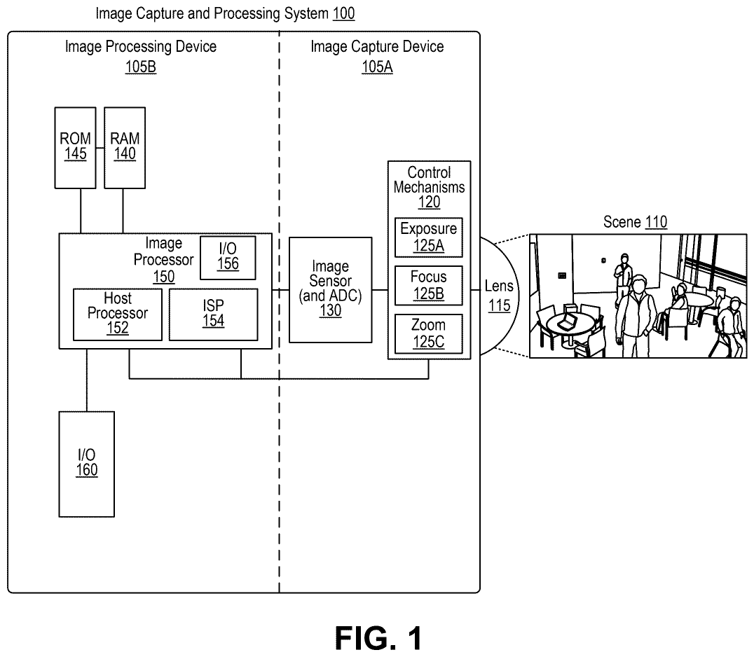

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. In further examples, the control mechanisms 120 can include controls to adjust an orientation of the image capture device 105A. For example, the control mechanisms 120 can include controls to adjust a pitch, roll, or yaw of the image capture device 105A, the image sensor 130, or the lens 115. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 2510 discussed with respect to the computing system 2500. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/2520, read-only memory (ROM) 145/2525, a cache 2512, a memory unit 2515, another storage device 2530, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 2535, any other input devices 2545, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can be part of a vehicle (e.g., a semi-autonomous or autonomous vehicle), mobile robot, drone, etc. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

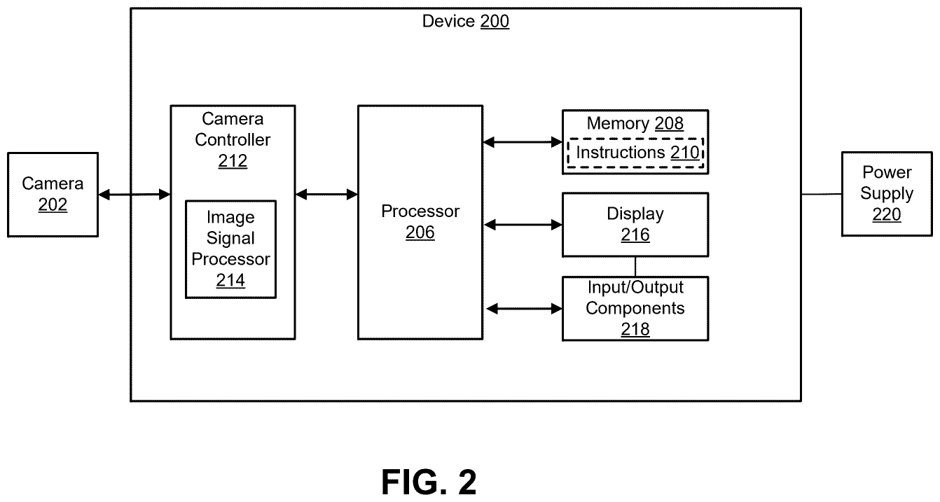

FIG. 2 is a block diagram of an example device 200 that can generate cylindrical projections (or other projections) of images generated by the image capture and processing system 100 and perform sensor calibration of the image capture and processing system 100. Device 200 may include or may be coupled to a camera 202, and may further include a processor 206, a memory 208 storing instructions 210, a camera controller 212, a display 216, and a number of input/output (I/O) components 218 including one or more microphones (not shown). The example device 200 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device. The device 200 may include additional features or components not shown. For example, a wireless interface, which may include a number of transceivers and a baseband processor, may be included for a wireless communication device. Device 200 may include or may be coupled to additional cameras other than the camera 202. The disclosure should not be limited to any specific examples or illustrations, including the example device 200.

Camera 202 may be capable of capturing individual image frames (such as still images) and/or capturing video (such as a succession of captured image frames). Camera 202 may include one or more image sensors (not shown for simplicity) and shutters for capturing an image frame and providing the captured image frame to camera controller 212. Although a single camera 202 is shown, any number of cameras or camera components may be included and/or coupled to device 200. For example, the number of cameras may be increased to achieve greater depth determining capabilities or better resolution for a given field of view (FOV). In some examples, camera 202 can be fish-eye camera, 360 camera, or other type of camera with various FOVs.

Memory 208 may be a non-transient or non-transitory computer readable medium storing computer-executable instructions 210 to perform all or a portion of one or more operations described in this disclosure. Device 200 may also include a power supply 220, which may be coupled to or integrated into the device 200.

Processor 206 may be one or more suitable processors capable of executing scripts or instructions of one or more software programs (such as the instructions 210) stored within memory 208. In some aspects, processor 206 may be one or more general purpose processors that execute instructions 210 to cause device 200 to perform any number of functions or operations. In additional or alternative aspects, processor 206 may include integrated circuits or other hardware to perform functions or operations without the use of software. While shown to be coupled to each other via processor 206 in the example of FIG. 2, processor 206, memory 208, camera controller 212, display 216, and I/O components 218 may be coupled to one another in various arrangements. For example, processor 206, memory 208, camera controller 212, display 216, and/or I/O components 218 may be coupled to each other via one or more local buses (not shown for simplicity).

Display 216 may be any suitable display or screen allowing for user interaction and/or to present items (such as captured images and/or videos) for viewing by the user. In some aspects, display 216 may be a touch-sensitive display. Display 216 may be part of or external to device 200. Display 216 may comprise an LCD, LED, OLED, or similar display. I/O components 218 may be or may include any suitable mechanism or interface to receive input (such as commands) from the user and/or to provide output to the user. For example, I/O components 218 may include (but are not limited to) a graphical user interface, keyboard, mouse, microphone and speakers, and so on.

Camera controller 212 may include an image signal processor (ISP) 214, which may be (or may include) one or more image signal processors to process captured image frames or videos provided by camera 202. For example, ISP 214 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 212 (such as the ISP 214) may implement various functionality, including imaging processing and/or control operation of camera 202 including control of an orientation of the camera. In some aspects, ISP 214 may execute instructions from a memory (such as instructions 210 stored in memory 208 or instructions stored in a separate memory coupled to ISP 214) to control image processing and/or operation of camera 202. In other aspects, ISP 214 may include specific hardware to control image processing and/or operation of camera 202. ISP 214 may alternatively or additionally include a combination of specific hardware and the ability to execute software instructions.

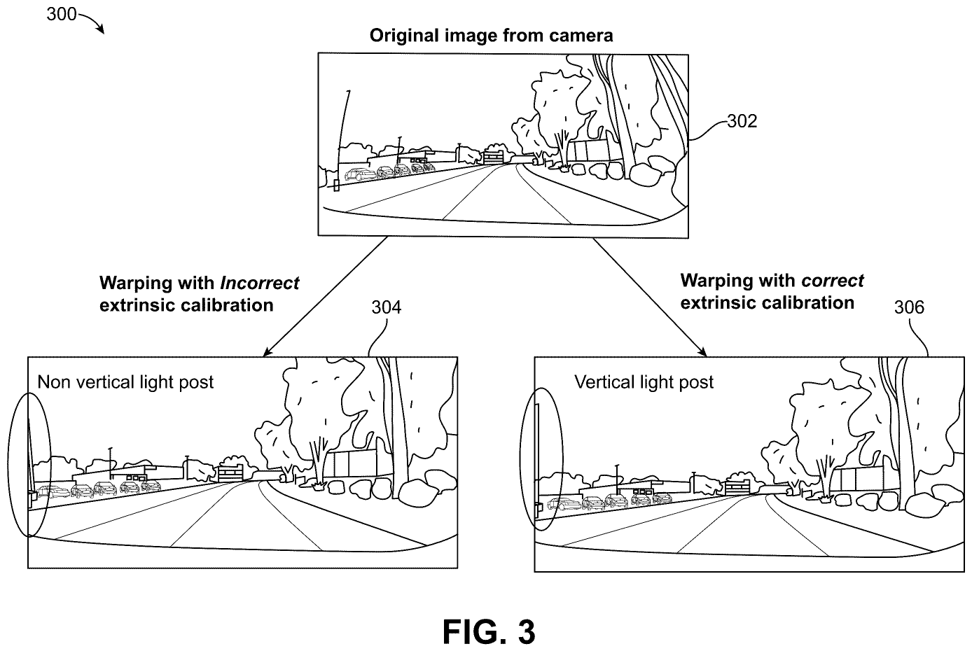

FIG. 3 is a block diagram is a block diagram 300 illustrating an example image 302 captured by an image sensor (e.g., an image sensor or camera of the image capture and processing system 100 of FIG. 1), a first cylindrical projection 304, and a second cylindrical projection 306. The image 302 is an image captured by an image sensor mounted on a vehicle (e.g., a car). The image depicts a road with a light post. The image 302 illustrates warping of objects depicted in the image (e.g., the light post) resulting from distortions of the image sensor. For example, the image sensor can be a camera with a fish-eye camera lens causing radial distortions around edges of the image and a curved horizon due to the wide field of view of the camera lens.

The first cylindrical projection 304 illustrates an example cylindrical projection of the image 302 with incorrect extrinsic calibration. For example, the first cylindrical projection 304 can have incorrect extrinsic calibration based on the image sensor capturing image 302 being at a different orientation or location than an expected orientation or location for which the image sensor is calibrated. For example, the image sensor can be shifted in orientation (e.g., different pitch, roll, or yaw). The first cylindrical projection 304 can be determined to be warped with incorrect extrinsic calibration based on the angle of the light post. For example, because the light post is depicted at an angle and not vertical, the first cylindrical projection 304 was generated with an incorrect extrinsic calibration.

The second cylindrical projection 306 depicts a cylindrical projection of image 302 with correct extrinsic calibration (e.g., the values used in generating the cylindrical projection accurately represent the orientation of the sensor). The second cylindrical projection 306 can be determined to be generated using correct extrinsic calibration because the light post is vertical and not curved, bent, or distorted.

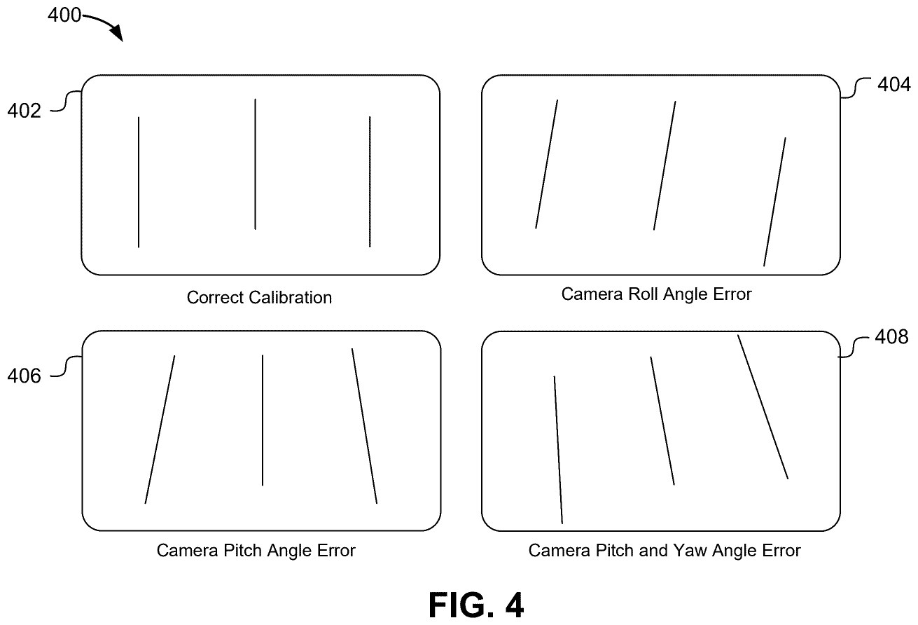

FIG. 4 is a block diagram illustrating cylindrical projections including reference lines used by a system for calibrating extrinsic parameters of a sensor (e.g., an image sensor or camera of the image capture and processing system 100 of FIG. 1). Cylindrical projection 402 illustrates an example cylindrical projection generated using correct extrinsic parameters of a sensor as illustrated by the reference lines being vertical lines. Cylindrical projections 404, 406, and 408 illustrate example cylindrical projections using incorrect extrinsic parameters of the sensor. The incorrect extrinsic parameters of the sensor are determined based on the angle of the reference lines. For example, cylindrical projections 404, 406, and 408 illustrate various inaccuracies in a sensor roll angle, pitch angle, and yaw angle when generating the cylindrical projection.

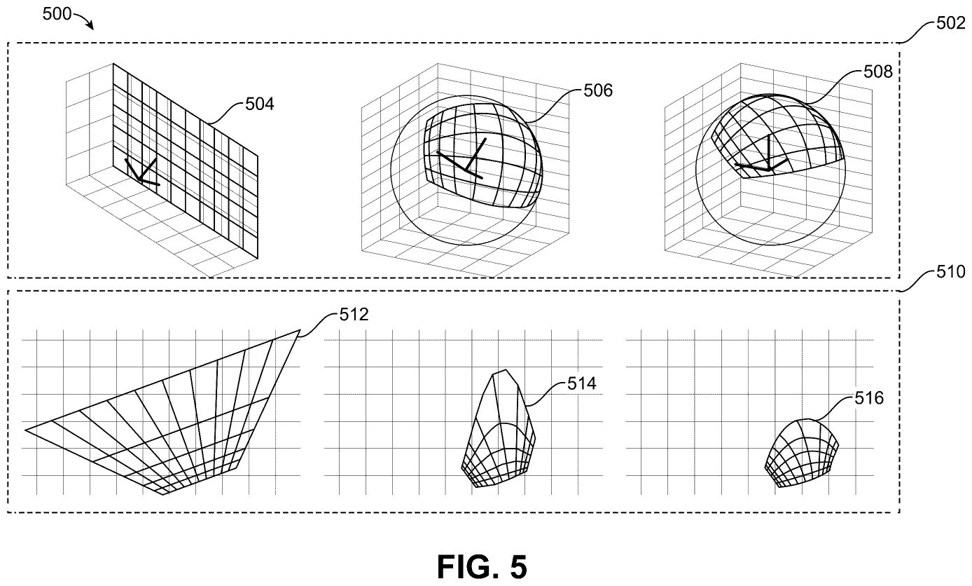

FIG. 5 is a block diagram 500 illustrating various example projections of straight vertical edges into images and effects of processing images to generate the example projections. The top row 502 illustrates a set of three-dimensional representations of straight lines. Solid lines are vertical in a world reference frame (e.g., based on a fixed, global coordinate system defining position and orientation of objects in an environment) and dashed lines are horizontal (to provide a visual aid of the orientation of the objects represented in the projection). Further, a reference frame of an image sensor used to capture the images is rotated relative the world frame.

The top left panel 504 illustrates the lines and the sensor in the cartesian world reference frame. The top middle panel 506 illustrates the lines projected on a unit sphere centered on the sensor. The top right panel 508 illustrates the lines projected on the unit sphere.

The bottom row 510 illustrates a set of 2D projections of the lines. The bottom left panel 512 illustrates a rectilinear (pinhole) projection. The bottom middle panel 514 illustrates a central cylindrical projection. The bottom right panel 516 illustrates an equirectangular cylindrical projection.

When the camera frame (e.g., image generated by the sensor) is aligned with the world frame, the two-dimensional (2D) projections illustrated in the bottom row 510 above represent vertical objects that are straight and vertical in the world as being straight and vertical in the projection (e.g., reference lines associated with the objects are straight and vertical in the projections). When the sensor is rotated relative the world frame, the reference lines will rotate, skew and bend based on the rotation. The deviation from the straight and the vertical can be used to detect that the camera is rotated relative to a horizontal world plane (e.g., rotated relative to the environment represented in the image with the environment being horizontal to the camera).

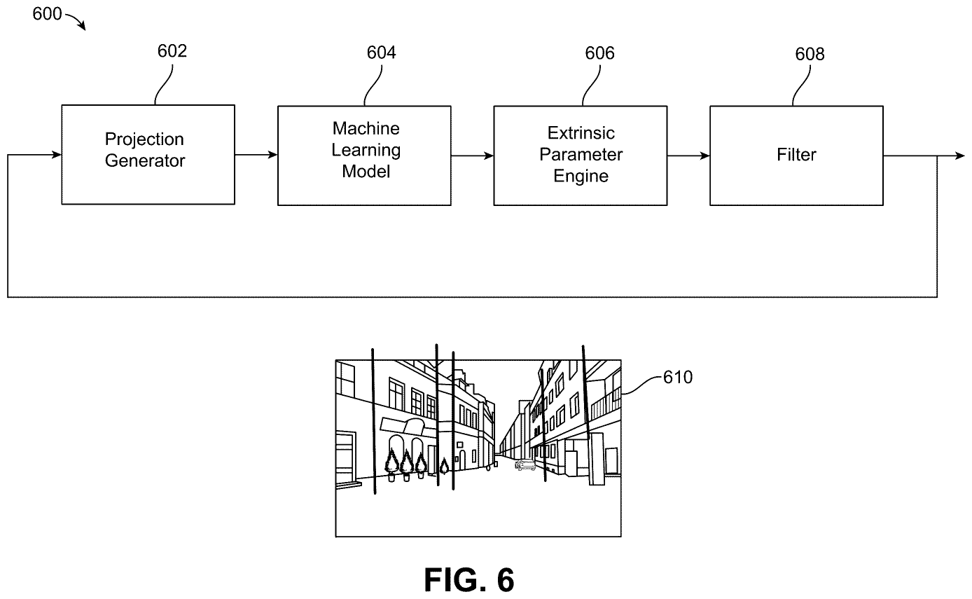

FIG. 6 is a block diagram illustrating example system 600 for calibrating parameters of a sensor. The system 600 includes a projection generator 602, a machine learning model 604, an extrinsic parameter engine 606, and a filter 608. The system 600 can receive an image generated by an image sensor (e.g., the image capture and processing system 100 of FIG. 1). The projection generator 602 can generate a cylindrical projection 610 based on the image using expected extrinsic parameters (e.g., extrinsic parameters to which the sensor is calibrated). For example, the projection generator 602 can use various algorithms to process the image to generate an equirectangular cylindrical projection of the image.

In some examples, the image used to generate the cylindrical projection can be selected using a selection engine (not shown in figure). In such an example, the selection engine can select an image based on kinesis of a system, device, or sensor generating the image. For example, the selection engine can select images to use for calibration based on movements of the sensor. In such an example, the sensor can be part of a vehicle (e.g., a car). Braking or acceleration of the vehicle can cause the vehicle to pitch causing misalignment between the sensor and a vertical world axis associated with the environment which the sensor is operating. Steering the vehicle can cause the vehicle to move in a roll direction. The selection engine can monitor vehicle acceleration and yaw rate to determine which images to use to calibrate the sensor. In such an example, the selection engine can select images associated with the vehicle in a steady state (e.g., driving forward in a substantially straight direction at substantially constant speed). In further examples, the selection engine can select images based on temperature data, impact data, or vibration data associated with the sensor. For example, calibration can be triggered based on a temperature, impact (e.g., physical contact), or vibration of the sensor or system 600.

The projection generator 602 can output the cylindrical projection 610. The machine learning model 604 can receive the cylindrical projection 610. The machine learning model 604 can determine reference lines associated with objects represented in the cylindrical projection. In some examples, the machine learning model 604 can be a classification model. The machine learning model 604 can perform object detection to classify objects represented in the image. For example, the machine learning model 604 can classify objects such as buildings, traffic signs, traffic lights, light posts, etc. The machine learning model 604 can be generate reference lines associated with the classified or detected objects. For example, the machine learning model 604 can be trained to determine reference lines of objects represented in the image. In such an example, the machine learning model 604 can detect an edge of a building and determine the edge of the building to be associated with a reference line.

The machine learning model 604 can output one or more reference lines associated with objects represented in the image. In some examples, the machine learning model 604 can output the cylindrical projection 610 including reference lines added to the cylindrical projection 610. The extrinsic parameter engine 606 can receive the one or more reference lines. The extrinsic parameter engine 606 can determine extrinsic parameters of the sensor used to generate the image based on the one or more reference lines.

For example, the extrinsic parameter engine 606 can back project the one or more reference lines onto a unit sphere (e.g., to generate a projection represented in the top right panel 508 of FIG. 5). In such an example, the extrinsic parameter engine 606 can generate latitudinal and longitudinal coordinates associated with points of the cylindrical projection 610. When the focal length of the sensor is known, the latitudinal and longitudinal points can be represented as:

$$lat = - \frac{u}{f} ; l o n = - \frac{v}{f}$$

with (u, v) representing a projected two-dimensional point. Other cylindrical projections can use different back projection equations. The previous equations can be specific to equirectangular cylindrical projections, as shown in the bottom right panel 516 of FIG. 5. Given the focal length of the sensor, the latitude and longitude can be defined as an elevation angle above a horizontal sensor plane (e.g., horizontal camera plane) and an azimuth angle in the horizontal sensor plane.

The extrinsic parameter engine 606 can determine an intersection point where the one or more reference lines intersect when back projected onto the unit sphere. The intersection point can represent an up-vector indicating an orientation. For example, reference lines back projected onto the unit sphere can be used to fit planes through the unit sphere (e.g., including the reference line and an origin point). Normal vectors (e.g., perpendicular to the fitted planes) of the fitted planes can span a plane that is parallel to a horizontal world plane (e.g., the horizontal world plane of the sensor generating the image). A world up-vector (e.g., vector indicating orientation of the environment in which the sensor generated the image) can be determined based on a cross-product of two normal vectors of the fitted planes. In examples where more than two normal vectors are determined, the up-vector can be computed using various least-squares techniques.

The extrinsic parameter engine 606 can determine parameters of the sensor based on the world up-vector. For example, the world up-vector can be part of a rotation matrix converting coordinates from the world frame to a frame of the sensor. The rotation matrix can be represented as a yaw-pitch-roll sequence of right-hand rotations. In such an example, the pitch and roll angles can be determined using: pitch=−arcsin(\hat{n}ₓ) and roll=atan2(\hat{n}_{y}, \hat{n}_{z}) where \hat{n}ₓ, \hat{n}_{y}, \hat{n}_{z} represent x, y, z components of a unit vector of normalized vector \hat{n}. Based on the pitch and roll angles determined using the world-up vector, The system 600 can adjust parameters of the sensor based on the pitch and roll angles determined using the world-up vector to calibrate the sensor.

The extrinsic parameter engine 606 can output the pitch angle, roll angle, and other parameters determined using the extrinsic parameter engine 606. The filter 608 can receive the parameters. The filter 608 can used to adjust the parameters output by the extrinsic parameter engine 606 based on past adjusted parameters. For example, the filter can be a Kalman filter (or other recursive algorithm) to determine the parameters of the sensor while removing noise (e.g., error) of the parameters. In another example, the filter can be used to compare adjustments to parameters of the sensor to previous adjustments to the parameters and generate a weighted average of the parameters. For example, the filter 608 can be used to determine a weighted average of the parameters using various images. For example, the system 600 can determine the parameters using an iterative process. In such an example, the iterative process can include using the image or the cylindrical projection 610 for multiple iterations of adjusting the parameters. In further examples, the iterative process can include using additional images or additional cylindrical projections for different iterations of adjusting the parameters. For example, a first image or first cylindrical projection can be used for a first iteration to determine parameters of the sensor. A second image or second cylindrical projection can be used for a second iteration to determine parameters of the sensor. The filter 608 can perform various weighting operations of the iterations to determine a weighted average of parameters of the sensor.

In some examples, the machine learning model 604 can be trained using supervised or unsupervised training to determine reference lines associated with objects. For example, the machine learning model 604 can be trained using annotated images or annotated cylindrical projections. The annotations of the annotated images or annotated cylindrical projections can include example reference lines. In further examples, the machine learning model can be a classification model to perform object detection to determine which objects represented in the image or cylindrical projection should be used to determine the reference lines. In some aspects, training of one or more of the machine learning systems or neural networks described herein (e.g., such as the machine learning model 604, the neural network 900, among various other machine learning networks described herein) can be performed using online training (e.g., in some case on-device training), offline training, and/or various combinations of online and offline training. In some cases, online may refer to time periods during which the input data (e.g., such as the images or cylindrical projection 610 of FIG. 6, etc.) is processed, for instance for performance of the sensor calibration implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

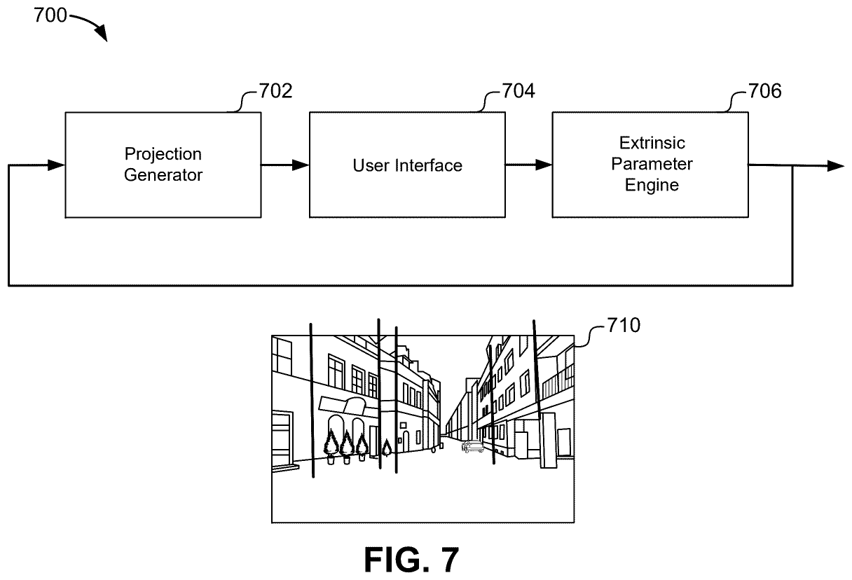

FIG. 7 is a block diagram illustrating another example system 700 for calibrating parameters of a sensor. The example system 700 includes a projection generator 702, a user interface 704, and an extrinsic parameter engine 706. The projection generator 702 can generate a cylindrical projection 710 based on the image. For example, the projection generator 702 can use various algorithms to process the image to generate the cylindrical projection of the image. In some examples, the cylindrical projection is an equirectangular cylindrical projection.

The projection generator 702 can output the cylindrical projection 710. The user interface 704 can convey for display the cylindrical projection 710 to a user. For example, the user interface 704 can be conveyed to a user using a display or screen of the system 700. In one example, the system 700 is part of a vehicle. In such an example, the user interface can be conveyed on a display of the vehicle, such as on a display associated with a backup camera of the vehicle or associated with an infotainment system of the vehicle. The user can provide inputs to the user interface to set reference lines associated with objects represented in the cylindrical projection 710. The user can adjust the cylindrical projection to straighten the reference lines to a vertical orientation. For example, the user can provide inputs to buttons of the infotainment system to adjust the cylindrical projection so that the reference lines are vertical. The user adjustments to the cylindrical projection and the parameters associated with the sensor can be provided to the extrinsic parameter engine 706. The extrinsic parameter engine 706 can determine parameters of the sensor based on the user inputs to straighten the reference lines. For example, each user input can be attributed a value adjust a roll angle, pitch angle, or yaw angle of the sensor. The extrinsic parameter engine 706 can determine the parameters of the sensor by calculating differences or additions to the parameters of the sensor based on the user adjustments. In further examples, the extrinsic parameter engine 706 can perform various extrinsic parameter operations described further in the description of the extrinsic parameter engine 606 of FIG. 6.

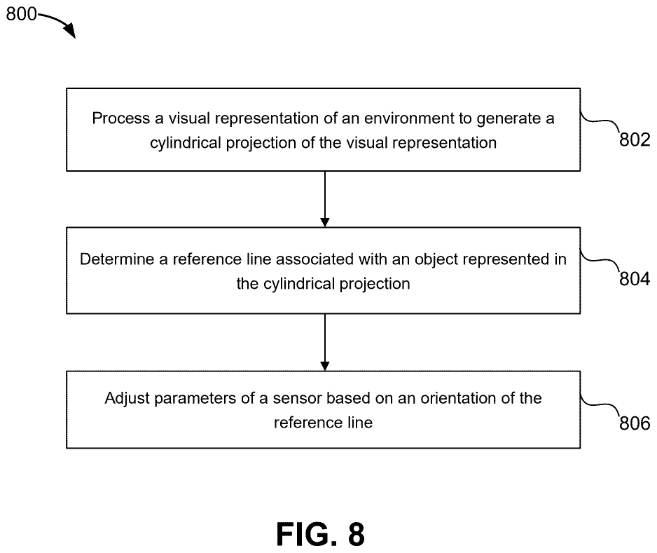

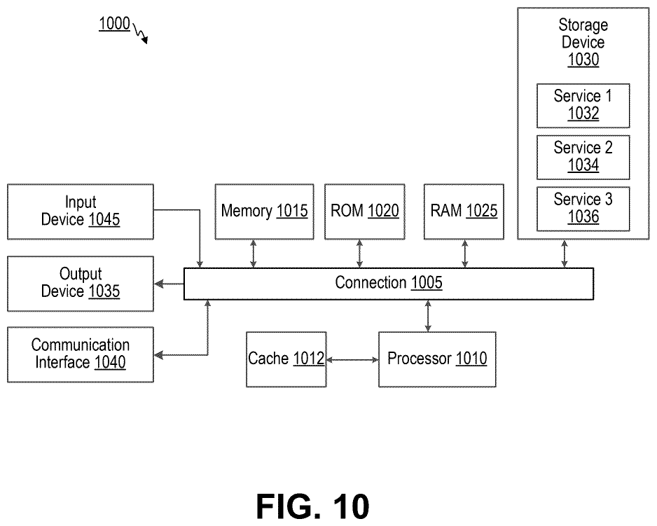

FIG. 8 is a flow diagram illustrating an example of a process 800 for calibrating a sensor. The process 800 can be performed by a computing device (e.g., system 100 of FIG. 1, device 200 of FIG. 2, computing device or computing system 1000 of FIG. 10, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 800 can be implemented as software components that are executed and run on one or more processors (e.g., processor 1010 of FIG. 10 or other processor(s)) of the computing device. Further, the transmission and reception of signals by the computing device in the process 800 can be enabled, for example, by one or more antennas and/or one or more transceivers (e.g., wireless transceiver(s)).

At block 802, the computing device (or component thereof) can process a visual representation of an environment to generate a cylindrical projection of the visual representation. In some examples, the visual representation is an image or a three-dimensional point cloud. In some examples, the computing device (or component thereof) can determine to process the visual representation based on a user selection. For example, a user can select to calibrate the sensor. In further examples, a user can select a visual representation from a plurality of visual representations to use to calibrate the sensor. In a further example, the computing device (or component thereof) can select the visual representation based on a movement of a vehicle.

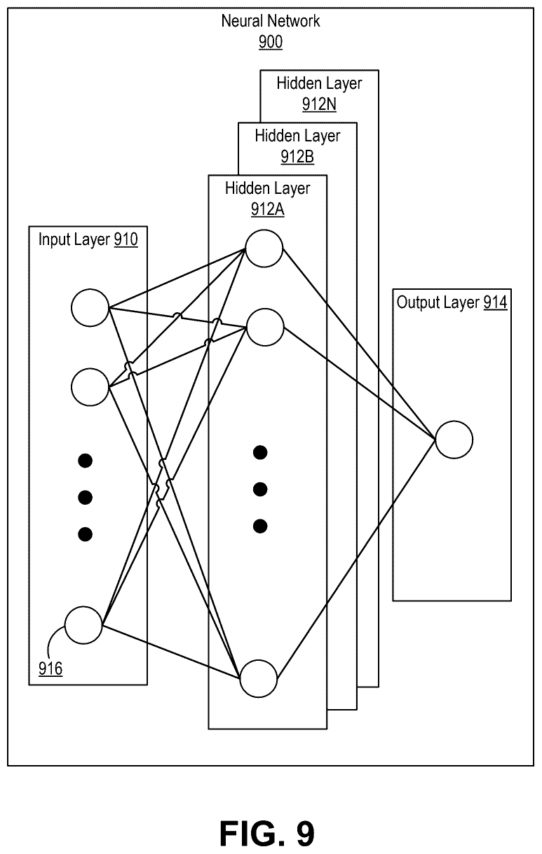

At block 804, the computing device (or component thereof) can determine a reference line associated with an object represented in the cylindrical projection. For example, the object can be an object in the real-world which is generally vertical and straight, such as a building, a street sign, or a light pole. In some examples, the computing device (or component thereof) can determine the reference line associated with the object represented in the cylindrical projection using a machine learning model (e.g., the machine learning model 604 of FIG. 6, the neural network 900 of FIG. 9, etc.). In such an example, the machine learning model can be trained using annotated visual representations, and wherein the annotated visual representations include reference lines associated with objects represented in the annotated visual representations. For example, the annotations can indicate objects represented within the visual representation which can be used to calibrate the sensor (e.g., objects which are vertical and straight).

At block 806, the computing device (or component thereof) can adjust parameters of a sensor based on an orientation of the reference line. In some aspects, the parameters can include at least one of a pitch or roll of the sensor. In some examples, the sensor can be an image sensor, an optical sensor, a camera, etc. In some aspects, the computing device (or component thereof) can adjust the parameters of the sensor based on the orientation of the reference line using a geometric relationship between an angle of the reference line and the sensor.

In some aspects, the computing device (or component thereof) can process the cylindrical projection to identify the object within the cylindrical projection. In such an example, the reference line can be a vertical line associated with the object. For example, the object can be a building. In such an example, the vertical line can be a line associated with a section of a building that is generally straight and vertical, such as an edge of the building. In other examples, the object can be an object in an environment which is generally straight and vertical such as a light pole, traffic sign, etc. In some aspects, the computing device (or component thereof) can filter the adjusted parameters of the sensor to compare adjustments to the parameters to a previous adjustment of the parameters. In a further example, the previous adjustment to the parameters can include an adjustment to an additional reference line associated with an additional object represented in the visual representation. In further examples, the computing device (or component thereof) can determine to process the visual representation based on a detected temperature, impact, or vibration of the sensor. For example, when a detected temperature of the sensor is greater than or less than a predetermined temperature range, the computing device (or component thereof) can determine to process the visual representation.

FIG. 9 is a block diagram illustrating an example of a neural network (NN) 900 that can be used for determining reference lines and object detection for calibrating a sensor. The neural network 900 can include any type of deep network, such as a convolutional neural network (CNN), an autoencoder, a deep belief net (DBN), a Recurrent Neural Network (RNN), a Generative Adversarial Networks (GAN), an auto-regressive transformer models, and/or other type of neural network.

An input layer 910 of the neural network 900 includes input data. The input data of the input layer 910 can include image data, 3D point clouds, voxel values, token representations of voxels, depth data, pose data, weight volume values, or a combination thereof. In some examples, the input data of the input layer 910 can include the plurality of tokens generated by the 3D sparse backbone engine described further in the description of FIG. 6 and FIG. 7. In some examples, the input data of the input layer 910 includes processed data that is to be processed further, such as various features, weights, intermediate data, output(s) of certain intermediate layer(s) or node(s), or a combination thereof.

The neural network 900 includes multiple hidden layers 912, 912B, through 912N. The hidden layers 912, 912B, through 912N include “N” number of hidden layers, where “N” is an integer greater than or equal to one. The number of hidden layers can be made to include as many layers as needed for the given application. The neural network 900 further includes an output layer 914 that provides an output resulting from the processing performed by the hidden layers 912, 912B, through 912N.

The neural network 900 is a multi-layer neural network of interconnected filters. Each filter can be trained to learn a feature representative of the input data. Information associated with the filters is shared among the different layers and each layer retains information as information is processed. In some cases, the neural network 900 can include a feed-forward network, in which case there are no feedback connections where outputs of the network are fed back into itself. In some cases, the network 900 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 910 can activate a set of nodes in the first hidden layer 912A. For example, as shown, each of the input nodes of the input layer 910 can be connected to each of the nodes of the first hidden layer 912A. The nodes of a hidden layer can transform the information of each input node by applying activation functions (e.g., filters) to this information. The information derived from the transformation can then be passed to and can activate the nodes of the next hidden layer 912B, which can perform their own designated functions. Example functions include convolutional functions, downscaling, upscaling, data transformation, and/or any other suitable functions. The output of the hidden layer 912B can then activate nodes of the next hidden layer, and so on. The output of the last hidden layer 912N can activate one or more nodes of the output layer 914, which provides a processed output image. In some cases, while nodes (e.g., node 916) in the neural network 900 are shown as having multiple output lines, a node has a single output and all lines shown as being output from a node represent the same output value.

In some cases, each node or interconnection between nodes can have a weight that is a set of parameters derived from the training of the neural network 900. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

In some aspects, training of one or more of the machine learning systems or neural networks described herein can be performed using online training (e.g., in some case on-device training), offline training, and/or various combinations of online and offline training. In some cases, online may refer to time periods during which the input data (e.g., such as the input data discussed with respect to the input layer 910) is processed, for instance for generating output data (e.g., such as the input data discussed with respect to the output layer 914). In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

The neural network 900 is pre-trained to process the features from the data in the input layer 910 using the different hidden layers 912, 912B, through 912N in order to provide the output through the output layer 914.

FIG. 10 is a diagram illustrating an example of a system for implementing certain aspects of the present technology. In particular, FIG. 10 illustrates an example of computing system 1000, which can be for example any computing device making up internal computing system, a remote computing system, a LIDAR sensor, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1000 includes at least one processor, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 1000 also includes a connection 1005 that couples various system components including system memory 1015, such as read-only memory (ROM) 1020 and random-access memory (RAM) 1025 to processor 1010. Computing system 1000 can include a cache 1012 of high-speed memory connected directly with, in close proximity to, or integrated as part of processor 1010.

Processor 1010 can include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 can essentially be a completely self-contained computing system, containing multiple cores or processors, a bus, memory controller, cache, etc. A multi-core processor can be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 can also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc. When the code that defines such software is executed by the processor 1010, the code causes the system to perform a function. In some aspects, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein can refer to any of the foregoing structure, any combination of the foregoing structure, or any other structure or apparatus suitable for implementation of the techniques described herein. In addition, in some aspects, the functionality described herein can be provided within dedicated software modules or hardware modules configured for encoding and decoding or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor can only perform at least a subset of operations X, Y, and Z.

Illustrative aspects of the disclosure include:
Aspect 1. An apparatus for sensor calibration, the apparatus comprising: at least one memory; and at least one processor coupled to the at least one memory and configured to: process a visual representation of an environment to generate a cylindrical projection of the visual representation; determine a reference line associated with an object represented in the cylindrical projection; and adjust parameters of a sensor based on an orientation of the reference line.
Aspect 2. The apparatus of Aspect 1, wherein the parameters include at least one of a pitch or roll of the sensor.
Aspect 3. The apparatus of any of Aspects 1 to 2, wherein the sensor is an image sensor.
Aspect 4. The apparatus of any of Aspects 1 to 3, wherein the at least one processor is configured to: process the cylindrical projection to identify the object within the cylindrical projection, and wherein the reference line is a vertical line associated with the object.
Aspect 5. The apparatus of any of Aspects 1 to 4, wherein the visual representation is an image or a three-dimensional point cloud.
Aspect 6. The apparatus of any of Aspects 1 to 5, wherein the object is a building, a street sign, or a light pole.
Aspect 7. The apparatus of any of Aspects 1 to 6, wherein the at least one processor is configured to: determine the reference line associated with the object represented in the cylindrical projection using a machine learning model.
Aspect 8. The apparatus of any of Aspects 1 to 7, wherein the machine learning model is trained using annotated visual representations, and wherein the annotated visual representations include reference lines associated with objects represented in the annotated visual representations.
Aspect 9. The apparatus of any of Aspects 1 to 8, wherein the at least one processor is configured to: adjust the parameters of the sensor based on the orientation of the reference line using a geometric relationship between an angle of the reference line and the sensor.
Aspect 10. The apparatus of any of Aspects 1 to 9, wherein the at least one processor is configured to: filter the adjusted parameters of the sensor to compare adjustments to the parameters to a previous adjustment of the parameters.
Aspect 11. The apparatus of any of Aspects 1 to 10, wherein the previous adjustment to the parameters includes an adjustment to an additional reference line associated with an additional object represented in the visual representation.
Aspect 12. The apparatus of any of Aspects 1 to 11, wherein the at least one processor is configured to: determine to process the visual representation based on a user selection.
Aspect 13. The apparatus of any of Aspects 1 to 12, wherein the at least one processor is configured to: determine to process the visual representation based on a detected temperature, impact, or vibration of the sensor.
Aspect 14. The apparatus of any of Aspects 1 to 13, wherein the at least one processor is configured to: select the visual representation based on a movement of a vehicle.
Aspect 15. A method for sensor calibration, the method comprising: processing a visual representation of an environment to generate a cylindrical projection of the visual representation; determining a reference line associated with an object represented in the cylindrical projection; and adjusting parameters of a sensor based on an orientation of the reference line.
Aspect 16. The method of Aspect 15, wherein the parameters include at least one of a pitch or roll of the sensor.
Aspect 17. The method of any of Aspects 15 to 16, wherein the sensor is an image sensor.
Aspect 18. The method of any of Aspects 15 to 17, further comprising: processing the cylindrical projection to identify the object within the cylindrical projection, and wherein the reference line is a vertical line associated with the object.
Aspect 19. The method of any of Aspects 15 to 18, wherein the visual representation is an image or a three-dimensional point cloud.
Aspect 20. The method of any of Aspects 15 to 19, wherein the object is a building, a street sign, or a light pole.
Aspect 21. The method of any of Aspects 15 to 20, further comprising: determining the reference line associated with the object represented in the cylindrical projection using a machine learning model.
Aspect 22. The method of any of Aspects 15 to 21, wherein the machine learning model is trained using annotated visual representations, and wherein the annotated visual representations include reference lines associated with objects represented in the annotated visual representations.
Aspect 23. The method of any of Aspects 15 to 22, further comprising: adjusting the parameters of the sensor based on the orientation of the reference line using a geometric relationship between an angle of the reference line and the sensor.
Aspect 24. The method of any of Aspects 15 to 23, further comprising: filtering the adjusted parameters of the sensor to compare adjustments to the parameters to a previous adjustment of the parameters.
Aspect 25. The method of any of Aspects 15 to 24, wherein the previous adjustment to the parameters includes an adjustment to an additional reference line associated with an additional object represented in the visual representation.
Aspect 26. The method of any of Aspects 15 to 25, wherein the previous adjustment to the parameters includes an adjustment to an additional reference line associated with an additional object represented in an additional cylindrical projection.
Aspect 27. The method of any of Aspects 15 to 26, further comprising: determining to process the visual representation based on a user selection.
Aspect 28. The method of any of Aspects 15 to 27, further comprising: determining to process the visual representation based on a detected temperature, impact, or vibration of the sensor.
Aspect 29. The method of any of Aspects 15 to 28, further comprising: selecting the visual representation based on a movement of a vehicle.
Aspect 30. A non-transitory computer-readable medium having stored thereon instructions that, when executed by at least one processor, cause the at least one processor to perform one or more of operations according to any of Aspects 15 to 29.
Aspect 31. An apparatus for sensor calibration, the apparatus comprising one or more means for performing operations according to any of Aspects 15 to 29.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for sensor calibration, the apparatus comprising:
at least one memory; and
at least one processor coupled to the at least one memory and configured to:
process a visual representation of an environment to generate a cylindrical projection of the visual representation;
determine a reference line associated with an object represented in the cylindrical projection; and
adjust parameters of a sensor based on an orientation of the reference line.

2. The apparatus of claim 1, wherein the parameters include at least one of a pitch or roll of the sensor.

3. The apparatus of claim 1, wherein the sensor is an image sensor.

4. The apparatus of claim 1, wherein the at least one processor is configured to:
process the cylindrical projection to identify the object within the cylindrical projection, and wherein the reference line is a vertical line associated with the object.

5. The apparatus of claim 1, wherein the visual representation is an image or a three-dimensional point cloud.

6. The apparatus of claim 1, wherein the object is a building, a street sign, or a light pole.

7. The apparatus of claim 1, wherein the at least one processor is configured to:
determine the reference line associated with the object represented in the cylindrical projection using a machine learning model.

8. The apparatus of claim 7, wherein the machine learning model is trained using annotated visual representations, and wherein the annotated visual representations include reference lines associated with objects represented in the annotated visual representations.

9. The apparatus of claim 1, wherein the at least one processor is configured to:
adjust the parameters of the sensor based on the orientation of the reference line using a geometric relationship between an angle of the reference line and the sensor.

10. The apparatus of claim 1, wherein the at least one processor is configured to:
filter the adjusted parameters of the sensor to compare adjustments to the parameters to a previous adjustment of the parameters.

11. The apparatus of claim 10, wherein the previous adjustment to the parameters includes an adjustment to an additional reference line associated with an additional object represented in the visual representation.

12. The apparatus of claim 1, wherein the at least one processor is configured to:
determine to process the visual representation based on a user selection.

13. The apparatus of claim 1, wherein the at least one processor is configured to:
determine to process the visual representation based on a detected temperature, impact, or vibration of the sensor.

14. The apparatus of claim 1, wherein the at least one processor is configured to:
select the visual representation based on a movement of a vehicle.

15. A method for sensor calibration, the method comprising:
processing a visual representation of an environment to generate a cylindrical projection of the visual representation;
determining a reference line associated with an object represented in the cylindrical projection; and
adjusting parameters of a sensor based on an orientation of the reference line.

16. The method of claim 15, wherein the parameters include at least one of a pitch or roll of the sensor.

17. The method of claim 15, further comprising:
processing the cylindrical projection to identify the object within the cylindrical projection, and wherein the reference line is a vertical line associated with the object.

18. The method of claim 15, further comprising:
determining the reference line associated with the object represented in the cylindrical projection using a machine learning model.

19. The method of claim 15, further comprising:
filtering the adjusted parameters of the sensor to compare adjustments to the parameters to a previous adjustment of the parameters.

20. A non-transitory computer-readable medium having stored thereon instructions that, when executed by at least one processor, cause the at least one processor to:
process a visual representation of an environment to generate a cylindrical projection of the visual representation;
determine a reference line associated with an object represented in the cylindrical projection; and
adjust parameters of a sensor based on an orientation of the reference line.
